(19) United States
(12) Patent Application Publication
(10) Pub. No.: US 2024/0243635 A1
(43) Pub. Date: Jul. 18, 2024

(54) DRIVE DEVICE FOR DRIVING A WATERCRAFT

(71) Applicant: ROSEN 2 Holding AG, Stans (CH)

(72) Inventor: Frank Fielers, Lingen (DE)

(21) Appl. No.: 18/558,648

(22) PCT Filed: May 3, 2022
(86) PCT No.: PCT/EP2022/061849

§ 371 Date: Nov. 2, 2023

(30) Foreign Application Priority Data
May 3, 2021 (DE) DE102021111401.2

(51) Int. Cl. H02K 7/09; B63B 34/10; B63H 21/17; B63H 23/32; F16C 32/04; H02K 5/132

(52) U.S. Cl. CPC H02K 7/09; B63H 21/17; B63H 23/321; F16C 32/0427; H02K 5/132; B63B 34/10; F16C 2326/30

(57) ABSTRACT

A drive device for driving a watercraft is provided. The drive device has a stator and has a rotor which, during operation, rotates relative to the stator about an axis of rotation. The axis of rotation is fixed in position in relation to the stator. The rotor is realized as an internal rotor. The rotor, at least during operation, is supported on the stator in the axial direction by means of a first axial bearing means.

### CROSS REFERENCE

This application claims priority to PCT Application No. PCT/EP2022/061849, filed May 3, 2022, which itself claims priority to German Patent Application No. 10 2021 111401.2, filed May 3, 2021, the entireties of both of which are hereby incorporated by reference.

### FIELD OF THE INVENTION

The invention relates to a drive device for driving a watercraft. The drive device has a stator and has a rotor which, during operation, rotates relative to the stator about an axis of rotation. The axis of rotation is fixed in position in relation to the stator. The rotor is realized as an internal rotor. The rotor, at least during operation, is supported on the stator in the axial direction by means of a first axial bearing means.

### BACKGROUND OF THE INVENTION

In the case of known drive devices of this type, the rotor realizes a flow channel in which, in order to generate forward motion, water is displaced by the rotation of the rotor, in an axial direction parallel to or coaxial with the axis of rotation. The force generated in the axial direction is transmitted to the stator, and thus to the user, by the first axial bearing means.

A disadvantage of known axial bearing means is their wear. This is substantial, in particular due to the diameter of the axial bearing means, which must exceed the diameter of the flow channel due to the rotor being realized as an internal rotor. This results both in considerable power losses and in high maintenance costs.

### BRIEF SUMMARY OF THE INVENTION

The object of the invention is to provide a drive device of the generic type that is more efficient and of a more compact structure.

The object is achieved according to the invention in that the first axial bearing means has at least one first rotor magnet device arranged on the rotor and at least one first stator magnet device arranged on the stator. The rotor magnet device is configured to realize a first rotor magnetic field. The first stator magnet device is configured to realize a first stator magnetic field. The axial bearing means is configured to realize a first bearing force that, owing to the first rotor magnetic field and the first stator magnetic field, acts between the first rotor magnet device and the first stator magnet device. The first bearing force acts at least to some extent in the axial direction.

The drive device serves in particular to displace water, for which purpose at least the rotor, in particular the entire drive device, is to be operated beneath the surface of the water. The rotor preferably has at least one blade or vane projecting into the flow channel, or is designed to receive at least one blade, or vane, projecting into the flow channel.

The rotor is in particular hubless or shaftless, or realized as a hollow shaft. Preferably, the axis of rotation does not intersect the rotor, but passes through a cavity formed by the rotor. The rotor is realized in particular as an impeller.

The stator comprises the part, or the components, of the drive device that does/do not rotate with the rotor during operation. In particular, the stator comprises a controller, a housing, input and/or output means for communication between the drive device and the user. During operation, the stator is in particular arranged in a fixed position on the watercraft to be driven or is comprised by the watercraft, watercraft comprising water sports equipment such as water sleds, foil boards and water bicycles. Preferably, the stator comprises or forms a motor. Alternatively, preferably the stator and the rotor together realize a motor, e.g. an electric motor, or surround the motor.

Preferably, the rotor is supported on the rotor at least by means of the first axial bearing means and, in particular, a separate first radial bearing means. The axial bearing means delimits, impedes or prevents a movement capability of the rotor relative to the stator in the axial direction. The first rotor magnet device is in particular arranged in a fixed position on the rotor or is comprised by the rotor. The first stator magnet device is in particular arranged in a fixed position on the stator or is comprised by the stator. The first rotor magnet device and/or the first stator magnet device preferably comprise/comprises at least one magnet. During operation, the first rotor magnetic field of the first rotor magnet device is superimposed on the first stator magnetic field of the first stator magnet device. The first bearing force results from the superimposition of the magnetic fields. The first rotor magnet device and the first stator magnet device are preferably attracted to or repelled from each other by the first bearing force.

The rotor can be displaced in particular by the first bearing force in the axial direction into a starting position. In particular, the rotor can be shifted at least slightly relative to the stator from the starting position in the axial direction and against the first bearing force. Following such a shift, the first bearing force, assuming the absence of further forces acting in the axial direction, causes the rotor to be shifted back to the starting position.

The design of the drive device according to the invention reduces or prevents wear and friction losses due to the axial bearing means, since during operation the rotor and the stator, or the first rotor magnet device and the first stator magnet device, have at least predominantly no contact in the axial direction. This makes it possible to increase the efficiency of the drive device and to achieve a desired forward motion even with a more compact motor.

In particular, the drive device does not have a bearing device that supports the rotor axially on the stator, and that is of a different type from the first axial bearing device. Preferably, the drive device does not have any axially acting, mechanical and/or hydrodynamic bearings by which the rotor is supported in the axial direction on the stator. Particularly preferably, the drive device has no axially acting ball, conical or plain bearing. In this way, the aforementioned advantages can be extended.

The first axial bearing means is preferably configured to realize the first bearing force in such a way that the first rotor magnet device, at least during operation, is repelled from the first stator magnet device by the first bearing force. This means, in particular, that the first stator magnet device and the first rotor magnet device, at least during operation, are at least to some extent magnetized oppositely to each other. In particular, like-named poles (north pole or south pole) of the first stator magnet device and of the first rotor magnet device face toward each other, at least to some extent, during operation or have a greater proximity to each other than differing poles. A particularly advantageous bearing characteristic is achieved in that the first bearing force is a bearing force that repels the first rotor magnet device from the first stator magnet device and the bearing force increases disproportionately as the distance between the first rotor magnet device and the first stator magnet device decreases.

Preferably, the first rotor magnet device and/or the first stator magnet device, at least during operation, are/is magnetized in the axial direction, at least to some extent, in particular exclusively. This means that a notional straight line through the north pole and the south pole of the respective magnet device is at an angle with respect to a plane arranged at right angles to the axis of rotation, or runs parallel to the axis of rotation. This form of magnetization allows the portion of the first bearing force acting in the axial direction to be generated in a particularly efficient manner.

The first rotor magnet device and/or the first stator magnet device are/is preferably realized by at least one permanent magnet. The at least one permanent magnet is in particular bonded to the (rest of the) rotor or stator. This makes it particularly easy to achieve the first bearing force without any separate energy requirement. Particularly preferably, the first rotor magnet device and/or the first stator magnet device comprise/comprises at least two, in particular exactly two, permanent magnets and/or no other magnet such as an electromagnet. Preferably, the first rotor magnet device and the first stator magnet device comprise an equal number of permanent magnets. In particular, the first stator magnet device and the first rotor magnet device are designed so as to be identical, or mirror-symmetrical, with respect to a mirror plane perpendicular to the axis of rotation.

Alternatively or in addition to the at least one permanent magnet, the first rotor magnet device and/or the first stator magnet device comprise/comprises at least one electromagnet. The advantage of the electromagnet compared to the permanent magnet in this case is that, with the electromagnet, the first bearing force can be set even when the distance between the first rotor magnet device and the first stator magnet device is constant.

Preferably, the first rotor magnet device and the first stator magnet device, at least during operation, are spaced at least substantially equidistant from the axis of rotation. Preferably, the first stator magnet device and/or the first rotor magnet device, or their respective at least one permanent magnet, are/is realized circumferentially, in particular rotationally symmetrically, around the axis of rotation. Particularly preferably, the first stator magnet device and/or the first rotor magnet device, or their respective at least one permanent magnet are/is in the form of a ring. This arrangement allows the first bearing force to be generated in a particularly homogeneous and space-saving manner along the entire circumference of the rotor, or stator. In an alternative embodiment, the first stator magnet device and/or the first rotor magnet device comprise/comprises a plurality of magnets, or permanent magnets, distributed along a circumference, which in particular together realize a ring shape.

Preferably, the first axial bearing means has a stop element by which a capability of the rotor to shift axially relative to the stator and against the first bearing force is delimited in such a way that contact between the first rotor magnet device and the first stator magnet device is prevented. In particular, contact of the respective included magnets is prevented. The stop element prevents damage to the magnets in the event of exceptional axial loads on the rotor.

In an advantageous design of the invention, a first axial interspace between the first stator magnet device and the first rotor magnet device is in fluid communication with an ambient space that at least partially surrounds the stator. This means that, during operation, water from the surroundings of the drive device enters the first axial interspace. This is advantageous in that cooling of the first stator magnet device and the first rotor magnet device is thereby achieved in a simple manner, and damping of a relative movement of the rotor relative to the stator is produced. In particular, the axial interspace is open toward the ambient space in two different, in particular opposite directions.

Preferably, the drive device has at least one second axial bearing means, by means of which the rotor, at least during operation, is supported on the stator in the axial direction. The second axial bearing means has at least one second rotor magnet device arranged on the rotor and configured to realize a second rotor magnetic field, and at least one second stator magnet device arranged on the stator and configured to realize a second stator magnetic field. The second axial bearing means is configured to realize a second bearing force that, owing to the second rotor magnetic field and the second stator magnetic field, acts between the second rotor magnet device and the second stator magnet device, and that acts at least to some extent in the axial direction and initially to some extents acts against the first bearing force. The second axial bearing means preferably has all or some of the features described above or in the following with regard to the first axial bearing means.

In a preferred design, the first stator magnet device and the second stator magnet device, or the first rotor magnet device and the second rotor magnet device, are realized in one piece and/or at least partially, in particular completely, by the same magnet or magnets. The respective magnet device in this case is particularly preferably arranged in the axial direction between the first rotor magnet device and the second rotor magnet device, the rotor magnetic fields of which then superimpose a common stator magnetic field, or is arranged between the first stator magnet device and the second stator magnet device, the rotor magnetic fields of which then superimpose a common rotor magnetic field.

The first axial bearing means and the second axial bearing means are in particular arranged in such a way that an electric motor is arranged at least in the axial direction at least partially between the first axial bearing means and the second axial bearing means. Preferably, in this case the rotor has at least one armature and the stator has at least one coil, or there is at least one armature arranged on the rotor and at least one coil arranged on the stator, the armature and the coil also being part of the electric motor. The armature and/or the coil are/is in particular at a lesser distance from the axis of rotation than the rotor magnet devices and/or the stator magnet devices. Preferably, the first axial bearing means is arranged in relation to the axial direction at one end of the rotor and the second axial bearing means at the other end of the rotor. This arrangement of the axial bearing means, or of the electric motor, results in a particularly compact design of the drive device.

Preferably, the first bearing force realized or to be realized as a maximum by the first axial bearing means in the case of a reference distance between the first rotor magnet device and the first stator magnet device exceeds the second bearing force realized or to be realized as a maximum by the second axial bearing means in the case of the reference distance between the second rotor magnet device and the second stator magnet device. This means that the magnetic fields generating the bearing forces differ, or the first axial bearing means differs from the second axial bearing means. If the magnet devices have as magnets only permanent magnets, it is the first bearing force that is realized, or the second bearing force that is realized, whereas, if the magnet devices in question have at least one electromagnet, it is the first bearing force that is to be realized as a maximum, or the second bearing force that is to be realized as a maximum. Due to this design of the drive device, the rotor, in the absence of externally applied axial forces, assumes an initial position in which the first rotor magnet device is at a different distance from the first stator magnet device than the second rotor magnet device is from the second stator magnet device. In this case, the axial bearing means can absorb different axial forces in and against the direction of forward motion, or there is an asymmetrical bearing force distribution. In this way, the drive device is suited to watercraft that have only one, or at least one preferred, direction of travel, that must be opposed by a greater bearing force, and further installation space can be saved. Preferably, the first axial bearing means is arranged in front of the second axial bearing means in the direction of forward motion of the watercraft.

Preferably, the second rotor magnet device and/or the second stator magnet device are/is realized by exactly one permanent magnet, or exactly one magnet ring formed by at least one permanent magnet. In particular in this case, the first rotor magnet device and/or the first stator magnet device are/is realized by two permanent magnets or two magnet rings formed by permanent magnets. The permanent magnets in this case are preferably of the same design. This makes it possible to achieve the previously described advantage of asymmetrical bearing force distribution by use of uniform components.

Preferably, the drive device has at least one first hydrodynamic radial bearing means. By means of the first radial bearing means, during operation the rotor is supported on the stator in the radial direction. The first radial bearing means preferably has at least one first stator radial bearing element arranged on the stator, and has at least one first rotor radial bearing element arranged on the rotor. A first radial interspace is realized, at least during operation, between the first stator radial bearing element and the first rotor radial bearing element. During operation, there forms in the first radial interspace a fluid layer that, in particular from a minimum rotational speed, is of a uniform height, measured in the radial direction, along the circumference of the first radial bearing means. The first stator radial bearing element and the first rotor radial bearing element thus form a hydrodynamic radial bearing, or plain bearing. Together with the one or more axial bearing means, this forms a particularly space-saving and reliable bearing arrangement of the rotor. To provide an optimal load-bearing capacity of the first radial bearing means, the first stator radial bearing element and the first rotor radial bearing element are in particular made of a ceramic, preferably of zirconium oxide or silicon carbide.

The first radial interspace is preferably in fluid communication with the ambient space surrounding the stator. Particularly preferably, the first radial interspace is in fluid communication with the first axial interspace. This causes the first radial interspace to be filled with water during operation. This also ensures sufficient cooling here. In addition, the use of water instead of typical lubricants eliminates the need to seal off the first radial bearing means from the ambient space, and thus saves further installation space.

At least when the rotor is arranged centrally, the first radial interspace has, with respect to the axis of rotation, a radial extent of at least 0.3 mm, preferably at least 0.5 mm and/or at most 1.2 mm, preferably at most 0.9 mm. The first radial interspace in this case preferably extends in a rotationally symmetrical manner. Particularly preferably, the first rotor radial bearing element and/or the first stator radial bearing element also extend/extends in a rotationally symmetrical manner. The first radial interspace preferably has an inner radius of at least 20 mm, particularly preferably of at least 30 mm. The inner radius is preferably only slightly greater than an outer radius of the flow channel realized by the rotor. Due to this design of the first radial interspace, the drive device has a particularly slim structural shape and is able to support the first radial bearing means, at least from a rotor rotational speed of 3000 revolutions per minute.

The first radial bearing means is arranged at least partially between the first or the second axial bearing means and the axis of rotation. In particular, a cross-section perpendicular to the axis of rotation and intersecting the first radial bearing means or the first radial interspace intersects the first or second axial bearing means or their axial interspace. This allows the rotor, or the flow channel, to be particularly short, and the water flowing through the interspaces only has a short distance to cover, thereby producing only slight losses.

Preferably, the drive device has at least one second hydrodynamic radial bearing means, by means of which the rotor, during operation, is supported on the stator in the radial direction, and which has a second stator radial bearing element arranged on the stator and a second rotor radial bearing element arranged on the rotor. Realized between the second stator radial bearing element and the second rotor radial bearing element, at least during operation, there is a second radial interspace, which in particular is in fluid communication with the ambient space, preferably in fluid communication with the first radial interspace by means of a fluid channel realized between the rotor and the stator. In particular in this case, an/the electric motor is arranged at least partially between the first radial bearing means and the second radial bearing means, at least in the axial direction. The second radial bearing means preferably has all or some of the features described above or in the following with regard to the first radial bearing means. The first radial bearing means is preferably identical in construction to the second radial bearing means. This design, in particular the design of the fluid channel through a plurality, or all, of the said interspaces and preferably between the coil and the armature of the electric motor, achieves a particularly efficient unreliable bearing arrangement.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a first exemplary embodiment of a drive device according to the invention, in a longitudinal section.

FIG. 2 shows a second exemplary embodiment of the drive device according to the invention, in a side view.

FIG. 3 shows the second exemplary embodiment of the drive device according to the invention, in a longitudinal section.

FIG. 4 shows the second exemplary embodiment of the drive device according to the invention, in a cross-section.

FIG. 5 shows a portion of the second exemplary embodiment of the drive device according to the invention, in an enlarged detail representation.

FIG. 6 shows a third exemplary embodiment of the drive derive according to the invention, in a front view.

FIG. 7 shows a watercraft having a drive device according to the invention, in a perspective representation.

### DETAILED DESCRIPTION OF THE DRAWINGS

The features of the exemplary embodiments according to the invention explained in the following may also constitute subject-matter of the invention individually or in combinations other than those represented or described, but always at least in combination with the features of claim 1. Where appropriate, functionally equivalent parts are denoted by identical reference numerals.

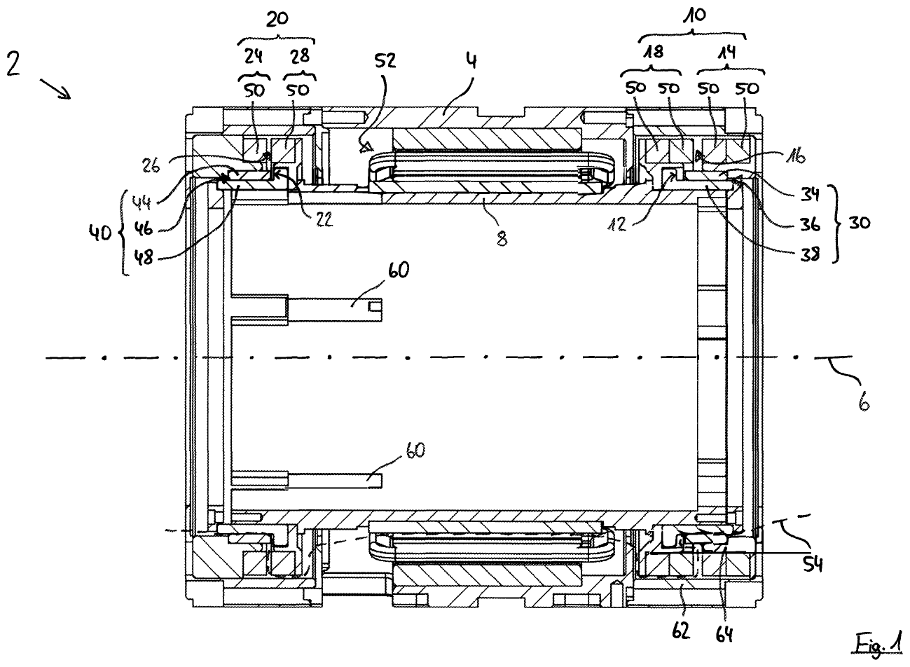

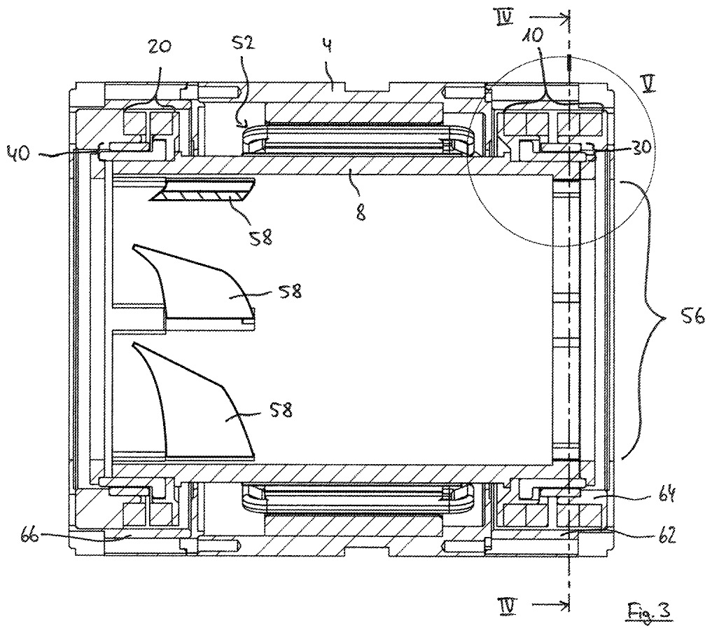

The figures show different exemplary embodiments of the drive device 2 according to the invention for driving a watercraft 70. Each of the exemplary embodiments has a stator 4, and has a rotor 8 that, during operation, rotates relative to the stator 4 about an axis of rotation 6 (see FIG. 1). The axis of rotation 6 is fixed in position relative to the stator 4. The rotor 8 is realized as an internal rotor. This means that the rotor 8 is realized as a hollow shaft, or is shaftless/hubless. The rotor 8 realizes a flow channel 56 extending longitudinally in the direction of the axis of rotation 6. In the first exemplary embodiment in this case, the rotor 8 has recesses 60 for the purpose of fastening blades, or vanes, for displacing water within the flow channel 56 (see FIG. 1). In the second exemplary embodiment, the rotor 8 comprises such blades, or vanes 58 (see FIG. 3).

The rotor 8 is supported on the stator 4 in the axial direction by means of a first axial bearing means 10 and a second axial bearing means 20. In the radial direction, the rotor 8 is supported on the stator 4 by means of a first hydrodynamic radial bearing means 30 and a second hydrodynamic radial bearing means 40. An electric motor 52 is arranged between the first axial bearing means 10 and the second axial bearing means 20 to generate a rotation of the rotor 8 relative to the stator 4.

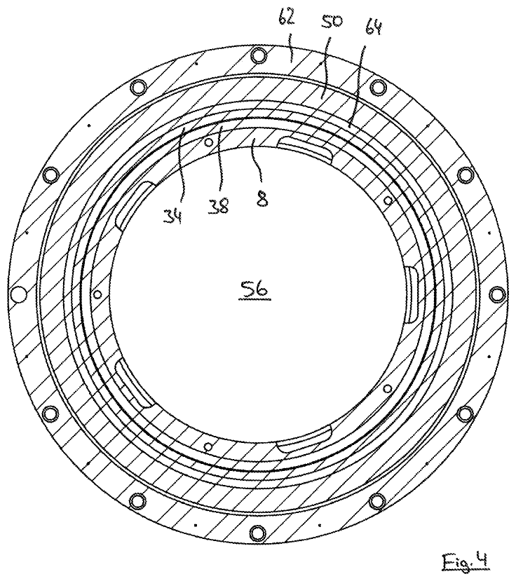

The first axial bearing means 10 has a first rotor magnet device 18 that is arranged on the rotor 8 and configured to realize a first rotor magnetic field. In addition, the first axial bearing means 10 has a first stator magnet device 14 that is arranged on the stator 6 and configured to realize a first stator magnetic field. The first rotor magnet device 18 and the first stator magnet device 14 each comprise two ring-shaped permanent magnets 50 (see in particular FIG. 4, cross-section along the sectional plane IV marked in FIG. 3) extending circumferentially around the axis of rotation 6. The first axial bearing means 10 is configured to realize a first bearing force acting, due to the first rotor magnetic field and the first stator magnetic field, between the first rotor magnet device 18 and the first stator magnet device 14 and at least to some extent in the axial direction.

Like the first axial bearing means 10, the second axial bearing means 20 has a second rotor magnet device 28 that is arranged on the rotor 8 and configured to realize a second rotor magnet field, and has a second stator magnet device 24 that is arranged on the stator 6 and configured to realize a second stator magnet field. In contrast to the first rotor magnet device 18 and the first stator magnet device 14, however, the second rotor magnet device 28 and the second stator magnet device 24 each comprise only one ring-shaped permanent magnet 50 extending circumferentially around the axis of rotation 6. The second axial bearing means 20, like the first axial bearing means 10, is configured to realize a second bearing force acting, due to the second rotor magnetic field and the second stator magnetic field, between the second rotor magnet device 28 and the second stator magnet device 24 and at least to some extent in the axial direction, the second bearing force being opposite in direction to the first bearing force.

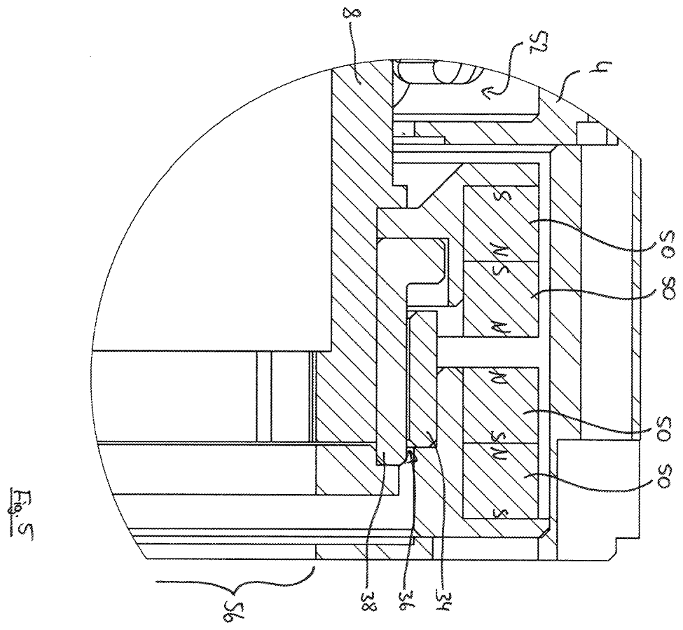

Both the first axial bearing means 10 and the second axial bearing means 20 are configured to realize a first and a second bearing force, respectively, in such a way that the first rotor magnet device 18 is repelled from the first stator magnet device 14 by the first bearing force, and the second rotor magnet device 28 is repelled from the second stator magnet device 24 by the second bearing force. The said permanent magnets 50 are magnetized exclusively in the axial direction. FIG. 5 is a detail representation of the portion circled in FIG. 3 and marked V, and shows that the different magnet devices 14, 18, 24, 28 of the same axial bearing means 10, 20 have permanent magnets 50 magnetized mutually oppositely and in the axial direction. Specifically, the north pole N of the first rotor magnet device 18 faces toward the north pole N of the first stator magnet device 14, with the south poles S facing away from each other. In this case, the permanent magnets 50 of the axial bearing means 10, 20 are of uniform design.

Since the second axial bearing means 20 has only two permanent magnets 50 and the first axial bearing means 10 has four permanent magnets 50, the first axial bearing means 10 is designed to realize a first bearing force that exceeds the second bearing force of the second axial bearing means 20. The first axial bearing means 10 generates stronger static magnetic fields than the second axial bearing means 20. As a result, a first axial interspace 16 provided between the first rotor magnet device 18 and the first stator magnet device 14 has, in an initial position of the drive device 2 in which it is represented in the figures and in which no further axial forces other than the bearing forces act upon the rotor, a greater axial extent than a second axial interspace 26 provided between the second rotor magnet device 28 and the second stator magnet device 24. In the initial position shown, the rotor 8, which can shift slightly in the axial direction relative to the stator 4, is in a position of equilibrium in which the first bearing force and the second bearing force cancel each other out. If the axial extent of the first axial interspace 16 were to coincide with the axial extent of the second axial interspace 26, the first bearing force would exceed the second bearing force.

Both the first axial bearing means 10 and the second axial bearing means 20 have a stop element 12 and 22, respectively. A capability of the rotor 8 to shift relative to the stator 4 and against the first or second bearing force is thereby delimited in such a way that contact between the first rotor magnet device 18 and the first stator magnet device 14, or the second rotor magnet device 28 and the second stator magnet device 24, is prevented. The stop element 12, or 22, is realized by a first rotor radial bearing element 38 or a second rotor radial bearing element 48, respectively, which together with a first stator radial bearing element 34 or a second stator radial bearing element 44, respectively, realizes a first hydrodynamic radial bearing means 30 or a second hydrodynamic radial bearing means 40, respectively. The radial bearing means 30, 40 support the rotor 8 on the stator 4 in the radial direction during operation. The stator radial bearing elements 34, 44 are arranged on the stator 4, and the rotor radial bearing elements 38, 48 are arranged on the rotor 8.

There is a radial interspace 36, 46 arranged between the radial bearing elements 34, 38, 44, 48 of a radial bearing means 30, 40 (see in particular FIG. 5). The radial interspaces 36, 46 serve during operation to create a lubricating film, with water being used as lubricant. The radial interspaces 36, 46 have a radial extent in the range of 0.5 mm to 0.9 mm. The radial interspaces 36, 46 and the axial interspaces 16, 26 are each in fluid communication with an ambient space surrounding the stator 4. Specifically, they form a fluid channel 54, which extends substantially parallel to the flow channel 56 and which also extends through between coils and permanent magnets of the electric motor 52, and the course of which is indicated in FIG. 1.

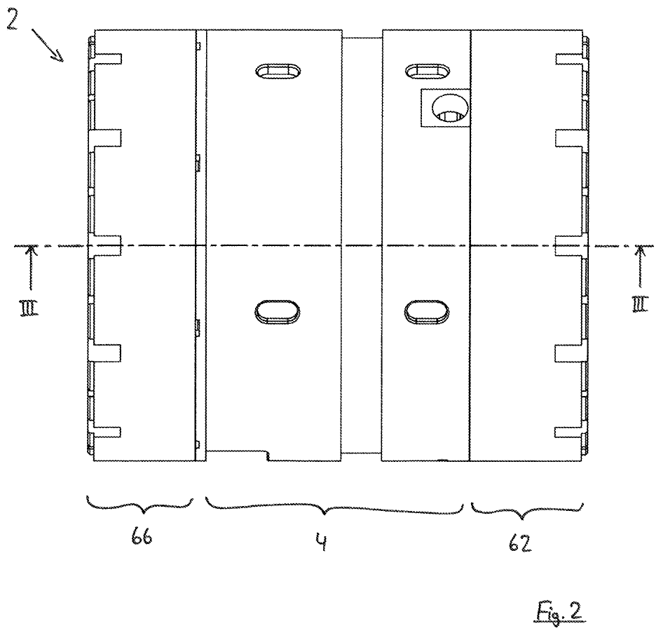

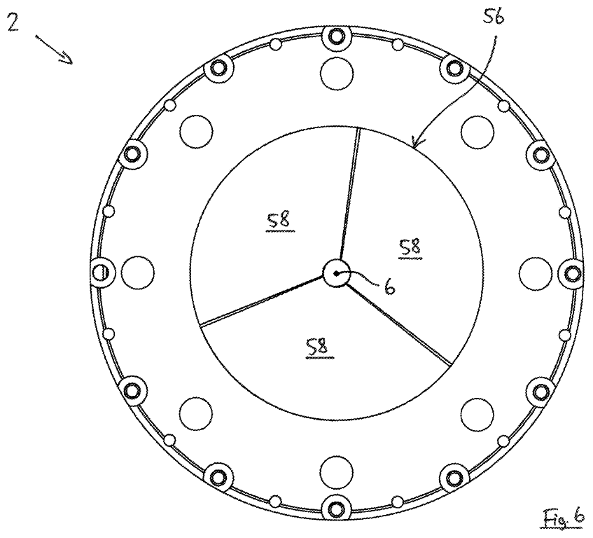

FIG. 3 is a sectional representation along the section line III shown in FIG. 2. FIG. 2 is a side view and shows, in addition to the stator 4, bearing caps 62, 66 that are bolted thereto and adjoin holding elements 64. FIG. 6 is a front view of a different exemplary embodiment of the drive device 2, which comprises blades, or vanes, 58 that differ from the blades, or vanes, 58 represented in FIG. 3.

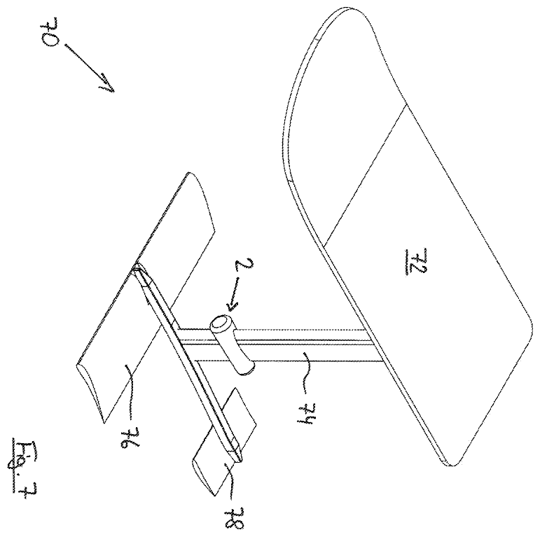

FIG. 7 shows a watercraft 70 realized as a foil board. It has a swim board 72, which inter alia is connected to a first wing 76 and a second wing 78 by means of a strut 74. There is a drive device 2 arranged in a detachable manner on the strut 74.

1. A drive device for driving a watercraft, the drive device comprising:
a stator;
a rotor which rotates relative to the stator about an axis of rotation that is fixed in position in relation to the stator, and wherein the rotor is an internal rotor supported, at least during operation, on the stator in the axial direction by a first axial bearing means,
wherein the first axial bearing means has at least one first rotor magnet device arranged on the rotor to realize a first rotor magnetic field, and wherein the first axial bearing has at least one first stator magnet device arranged on the stator to realize a first stator magnetic field, and realizes a first bearing force that, owing to the first rotor magnetic field and the first stator magnetic field, acts between the first rotor magnet device and the first stator magnet device and at least partially in the axial direction.

2. The drive device as claimed in claim 1, wherein the first axial bearing means realizes the first bearing force in such a way that the first rotor magnet device, at least during operation, is repelled from the first stator magnet device by the first bearing force.

3. The drive device as claimed in claim 1, wherein the first rotor magnet device and/or the first stator magnet device, at least during operation, are/is at least partially magnetized in the axial direction.

4. The drive device as claimed in claim 1, wherein the first rotor magnet device and/or the first stator magnet device are/is realized by at least one permanent magnet.

5. The drive device as claimed in claim 1, wherein the first rotor magnet device and the first stator magnet device, at least during operation, are spaced at least substantially equidistant from the axis of rotation.

6. The drive device as claimed in claim 1, wherein the first axial bearing means has a stop element by which a capability of the rotor to shift axially relative to the stator and against the first bearing force is delimited in such a way that contact between the first rotor magnet device and the first stator magnet device is prevented.

7. The drive device as claimed in claim 1, wherein a first axial interspace between the first stator magnet device and the first rotor magnet device is in fluid communication with an ambient space that at least partially surrounds the stator.

8. The drive device as claimed in claim 1, further including at least one second axial bearing means, by which the rotor, at least during operation, is supported on the stator in the axial direction, and which has at least one second rotor magnet device arranged on the rotor to realize a second rotor magnetic field, and at least one second stator magnet device arranged on the stator to realize a second stator magnetic field, and which realizes a second bearing force that, owing to the second rotor magnetic field and the second stator magnetic field, acts between the second rotor magnet device and the second stator magnet device, and that acts at least partially in the axial direction and at least partially acts against the first bearing force.

9. The drive device as claimed in claim 8, wherein an electric motor is arranged at least in the axial direction at least partially between the first axial bearing means and the second axial bearing means.

10. The drive device as claimed in claim 8, wherein the first bearing force realized or to be realized as a maximum by the first axial bearing means in the case of a reference distance between the first rotor magnet device and the first stator magnet device exceeds the second bearing force realized or to be realized as a maximum by the second axial bearing means in the case of the reference distance between the second rotor magnet device and the second stator magnet device.

11. The drive device as claimed in claim 8, wherein the second rotor magnet device and/or the second stator magnet device are/is realized by exactly one permanent magnet.

12. The drive device as claimed in claim 1, further including at least one first hydrodynamic radial bearing means, by which, during operation, the rotor is supported on the stator in the radial direction and which has at least one first stator radial bearing element arranged on the stator, and has at least one first rotor radial bearing element arranged on the rotor, between which there is realized, at least during operation, a first radial interspace that is in fluid communication with an ambient space surrounding the stator.

13. The drive device as claimed in claim 12, wherein at least when the rotor is arranged centrally, the first radial interspace has, with respect to the axis of rotation, a radial extent of at least 0.3 mm and/or at most 1.2 mm.

14. The drive device as claimed in claim 12, wherein characterized in that the first radial bearing means is arranged at least partially between the first or the second axial bearing means and the axis of rotation.

15. The drive device as claimed in claim 12, further including at least one second hydrodynamic radial bearing means, by which the rotor, during operation, is supported on the stator in the radial direction, and which has a second stator radial bearing element arranged on the stator and a second rotor radial bearing element arranged on the rotor, realized between which, at least during operation, there is a second radial interspace, which is in fluid communication with an ambient space surrounding the stator.

16. The drive device as claimed in claim 5, wherein the first stator magnet device and/or the first rotor magnet device are/is realized circumferentially around the axis of rotation.

17. The drive device as claimed in claim 11, wherein the first rotor magnet device and/or the first stator magnet device are/is realized by two permanent magnets, wherein the permanent magnets are of the same design.

18. The drive device as claimed in claim 14, wherein first radial bearing means, in a cross-section perpendicular to the axis of rotation, is arranged at least partially between the first or the second axial bearing means and the axis of rotation.

19. The drive device as claimed in claim 15, wherein the second radial interspace is in fluid communication with the first radial interspace by a fluid channel realized between the stator and the rotor.

20. The drive device as claimed in claim 15, wherein the electric motor is arranged at least partially between the first radial bearing means and the second radial bearing means, at least in the axial direction.
